(19) United States
(12) Patent Application Publication
(10) Pub. No.: US 2020/0242292 A1
(43) Pub. Date: Jul. 30, 2020

(54) POWER NETWORK DC INTEGRITY CHECKS OF PCBS

(71) Applicant: THE REGENTS OF THE UNIVERSITY OF CALIFORNIA, OAKLAND, CA (US)

(72) Inventor: Sheldon Tan, Irvine, CA (US)

(21) Appl. No.: 16/651,259

(22) PCT Filed: Sep. 26, 2018
(86) PCT No.: PCT/US2018/052997

§ 371 Date: Mar. 26, 2020

Related U.S. Application Data
(60) Provisional application No. 62/563,587, filed on Sep. 26, 2017.

(51) Int. Cl. G06F 30/373; H05K 3/00; G06F 30/23

(52) U.S. Cl. CPC G06F 30/373; G06F 2119/02; G06F 30/23; H05K 3/0005

(57) ABSTRACT

A system and method for integrity analysis of a printed circuit board comprises a processor and a first set of instructions executable on the processor configured to use a two-dimensional mesh for the analysis of the printed circuit board to reduce the number of elements in a mesh representing the printed circuit board. A second set of instructions are executable on the processor are configured to use a resistive line to replace all vias and a third set of instructions are executable on the processor configured to approximate the contours of shapes in the printed circuit board to further reduce the number of elements.

### CROSS-REFERENCE TO RELATED APPLICATIONS

This application claims the benefit of International PCT Application No. PCT/US2018/052997, filed on Sep. 26, 2018, which claims the benefit of U.S. Provisional Patent Application No. 62/563,587, filed on Sep. 26, 2017, the entire contents of which are hereby expressly incorporated herein by reference.

### GOVERNMENT LICENSE RIGHTS

This invention was made with government support under Grant No. CCF-1527324 awarded by The National Science Foundation. The government has certain rights in the invention.

### TECHNICAL FIELD

This disclosure relates generally to power network DC integrity checks of printed circuit boards (PCBs), and more specifically to a fast two-dimensional finite element analysis for power network DC integrity checks of PCBs.

### BACKGROUND

Power delivery network integrity is very important for the high-performance printed circuit boards (PCBs) designs. The direct current (DC) analysis of power/ground networks in PCBs plays the central roles for the power delivery integrity checks.

For high-performance printed circuit board (PCB) and package designs, the power ground network integrity (such as DC current density, DC voltage IR drops) needs to be checked to ensure the long-term reliability operations of the PCBs and circuit systems. Improper power ground network design may lead to excessive voltage IR drops and DC current, which will cause serious reliability problems to the PCBs.

DC analysis for electronic circuits such as PCBs, packages and integrated circuits essentially relates to solving the Laplace or Poisson partial differential equations (PDE), which comes from more general Maxwell equations as described in J. A. Stratton, Electromagnetic Theory, New York: McGraw-Hill, 1941, J. D. Kraus, Electromagnetics (4th edition), New York, McGraw-Hill, 1973, and J. D. Jackson, Classical Electrodynamics (2nd edition). New York: Wiley, 1975. There are many numerical methods in solving the differential equation or integral equation derived from the general Maxwell equations. The 3D finite element method (FEM), based solution as described in J.-M. Jin, The Finite Element Method in Electromagnetics, New York, Wiley, 2002, is a general numerical approach to this problem with good accuracy. However, this method typically suffers high computational costs and a large memory footprint due to too many unknowns (or a large number of elements generated), especially in iterative designs of PCBs. Other methods like partial element equivalent circuit (PEEC), as described in A. E. Ruehli, “Equivalent circuit models for three-dimensional mul-ticonductor systems,” IEEE Transactions on Microwave Theory and Techniques, vol. 22, pp. 216-221, March 1974, and the finite-difference time-domain (FDTD) method, as described in R. Mittra, S. Chebolu, and W. D. Becker, “Efficient modeling of power planes in computer packages using the finite difference time domain method,” IEEE Transactions on Microwave Theory and Techniques, vol. 42, pp. 1791-1795, September 1994, also suffer the same problem. Method of moments, as described in R. F. Harrington, Field Computation by Moment Methods. Malaba: Krieger, 1982, can solve electromagnetic boundary or volume integral equations in the frequency domain, but leads to dense, even full matrices to solve though it has fewer unknowns.

Thus, there is a need for a solution that provides for a reduced number of elements, providing more efficiency, without a signification loss in accuracy.

### SUMMARY

One aspect of the invention relates to a novel two-dimensional finite element method (FEM) based DC power networks integrity analysis for PCBs. Unlike the existing 3D finite element-based DC analysis, such as the Cadence Sigrity PowerDC tool, 2D finite elements are used in the new method for space discretization so that the number of elements can be significantly reduced. To model the vertical interconnect accesses (vias) and horizontal connects among different layers and parts in PCBs, simple resistive line elements are used to further reduce elements. To further reduce the number of elements, a novel contour shape modeling method is introduced to trade off efficiency and accuracy. Experimental results show that the proposed 2D PCB DC solver is 29.29% faster than the commercial PowerDC tools with similar accuracy for industry PCB designs.

### BRIEF DESCRIPTION OF THE DRAWINGS

FIG. 1a illustrates an example network printed circuit board (PCB) according to one embodiment.

FIG. 1b illustrates a power network of the PCB of FIG. 1a.

FIG. 2 illustrates a right perspective 3D view of an Intel Galileo PCB.

FIG. 3a illustrates, for practical power networks in PCBs, a 3D structure.

FIG. 3b illustrates the original 3D structure converted by one embodiment to several 2D planes connected by vertical line segments, which can be represented by 2D elements (lines or triangles) completely.

FIG. 4a illustrates a round pin pad that is taken for demonstration both for voltage and current BCs.

FIG. 4b illustrates another round pin pad that is taken for demonstration both for voltage and current BCs.

FIG. 5a illustrates a dense meshing before it is simplified.

FIG. 5b illustrates a partially enlarged area indicated in the rectangle of FIG. 5(a).

FIG. 5c illustrates a sparse meshing after it has been simplified by the system.

FIG. 5d illustrates the partial enlarged area of the rectangle in FIG. 5c after the meshing has been simplified.

FIG. 6a is a voltage distribution plot that resulted from the 2D FEM solver.

FIG. 6b is a current density distribution plot that resulted from the 2D FEM solver.

FIG. 6c is a voltage distribution plot on the power (PWR) layer that resulted from the PowerDC.

FIG. 6d is a current density distribution plot on the PWR layer that resulted from the PowerDC.

### DETAILED DESCRIPTION

### I. Introduction

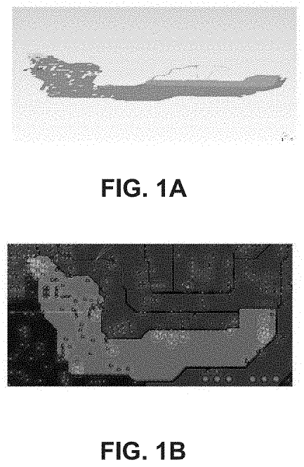

With reference to FIG. 1a, a network V1P0 S0 is selected from the Intel Galileo G87173 204 PCB for the purpose of testing. The board has a total of six copper layers: top, power, lyr 1, lyr 2, ground and bottom, while the V1P0 S0 network is distributed on the top power and bottom layers. In FIG. 1a, the geometrical 3D-display of the power network of the V1P0 S0 is shown. In FIG. 1b, the highlighted area is part of the power network of the V1P0 S0 shown in FIG. 1(a). The practical network has many complicated structures (vias, planes) and layers and boundary conditions (voltage and current sources). The finite element method (FEM) described herein is a good fit for the PCB shown and described in FIGS. 1a and 1b because the method is well suited for complicated structures and it naturally handles the two boundary conditions. The method further helps to mitigate high computational costs.

The method and system described herein performs DC analysis for PCBs, including detection of excessive voltage IR drop, areas of excess current density and even power and thermal hotspots. The system and method uses a novel two-dimensional finite element method (FEM) based DC power network integrity analysis for PCBs. Unlike the existing 3D finite element-based DC analysis such as the Cadence PowerDC tool, the system applies 2D finite elements for space discretization so that the number of elements can be significantly reduced. To model the vertical vias and horizontal connects among different layers and parts in PCBs, simple resistive line elements are employed. To further control the number of elements to be used, contour shape modeling is introduced so that it can perform with efficiency and accuracy. The numerical results show that the described 2D PCB DC solver is 29.29% faster than the commercial PowerDC with similar accuracy on practical industry PCB designs.

### II. Review of Finite Element-Based Solver for Steady State Electrical Field

The finite element method (FEM) was introduced in 1940 for solving partial differential equations (PDEs) for initial and boundary-value problems, and is described in H. Martin and G. Carey, Introduction to Finite Element Analysis: Theory and Application, New York, McGraw-Hill, 1973. Based on the mathematical theory of the weak solution of PDEs, FEM can deal with Neumann boundary conditions (BCs) in a natural way and it can also deal with irregular geometrics much more easily. A brief review of the steady-state electrical field solving process, which can be viewed as FEM for Poisson's equation with Dirichlet and Neumann boundary conditions, follows.

For an electrical field in the steady state, the following formula applies:

$$E = - ∇ V , ∇ \cdot E = \frac{ρ}{{ϵ}_{0}} .$$

where V is the voltage potential and E is the electrical field vector. Then there is the so-called Poisson's equation in the differential form:

$${∇}^{2} V = - \frac{ρ}{{ϵ}_{0}}$$

For steady state electrical field with constant current flow, i.e., ρ=0, there ends up a Laplace equation ∇²ϕ=0, and there are the following boundary conditions:

vᵢ(t=0)=vᵢ₀,i=1 . . . m(voltage)

iᵢ(t=0)=iᵢ₀,i=1 . . . k(voltage)

In general, the electrical potential Vin steady state can be described by the Poisson's equation with both Dirichlet and Neumann boundary conditions given as follows:

∇²V=f(x),xϵΩ,

V=u(x),xϵΓ_{D},

∇V·N=g(x),xϵΓ_{N},

where Ω⊂Rⁿ is the solution domain with the boundary ∂Ω, Γ_{D} (is the part of the boundary where Dirichlet boundary conditions are given, Γ_{N} is the part of the boundary where Neumann boundary conditions are given V(x) is unknown electrical field to be found, f(x), u(x), and g(x) are given electrical charges and voltage sources and current sources.

The weak formulation for FEM is used for real computation due to that it is difficult to enforce Dirichlet and Neumann boundary conditions. Given the test function s, then:

∫_{Ω}(ΔV−f)·sdΩ=0.

Integrating this equation by part and applying the divergence theorem, obtains the following:

∫_{Ω}∇V·∇sdΩ=∫_{Γ}_{_{D}}s·(∇V·n)dΓ+∫_{Γ}_{_{N}}s·(∇V·n)dΓ−∫_{Ω}f·sdΩ.

For Dirichlet boundary condition, the integral term ∫_{Γ}_{_{D}}s(∇V·n)dΓ in vanishes and hence the weak form of Poisson's equation for VϵV(Ω) and s sϵV₀(Ω) becomes:

∫_{Ω}∇V·∇sdΩ=∫_{Γ}_{_{N}}s·(∇V·n)dΓ−∫_{Ω}f·sdΩ,V(x)=u(x),xϵΓ_{D}.

Dirichlet BC is called Essential Boundary Conditions, as it is not a part of the weak) form. For Neumann boundary condition, g(x)=∇V·n and the integral term over the Neumann surface contains exactly the same flux, so:

∫_{Ω}∇V·∇sdΩ=∫_{Γ}_{_{N}}g·sdΓ−∫_{Ω}f·sdΩ.

Neumann BC is called Natural Boundary Conditions, as is part of the weak form. The resulting weak form for the Poisson's problem can now be written. For any test function sϵV₀(Ω), we need to find VϵV(Ω) such that:

∫_{Ω}∇V·∇sdΩ=∫_{Γ}_{_{N}}g·sdΓ−∫_{Ω}f·sdΩ,V(x)=u(x),xϵΓ_{D}.

To solve numerically given problem based on this weak form, the following algorithm with five steps is used:

Finite element solver for Poisson's equation:
1: Define the domain Ω and the surfaces Γ_{D} and Γ_{N}.
2: Define the known functions f, u, and g.
3: Define the unknown function V and the test function s.
4: Define essential boundary conditions (Dirichlet conditions)

V(x)=u(x),xϵΓ_{D}.
5: Define equation and natural boundary conditions (Neumann conditions) as the set of all integral terms ∫_{Ω}∇V·∇sdΩ,∫_{Γ}_{_{N}}g·sdΓ,∫_{Ω}f·sdΩ.

### III. NEW 2D FEM DC SOLUTION FOR PCBS

The new 2D FEM solver may use, in one embodiment, two new approximation methods to speed up the FEM analysis for power networks analysis of PCBs.

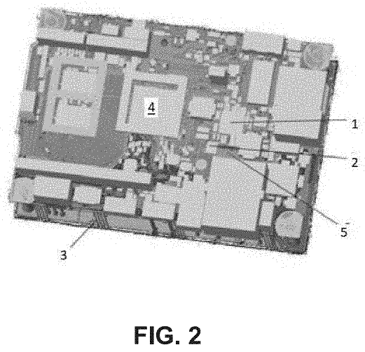

A power network in PCBs usually contains five elements: electrical source 1, copper clad laminate (CCL) 5, via 3, discrete component 2 and IC load 4 as shown in FIG. 2. Since the thickness of the copper clad laminate 5 is uniform on each layer (there may be many layers), an identical electrical potential value can be assumed in the vertical or z direction. Therefore, the layer can be regarded as a geometrical plane assuming the voltage is same in the z direction. As a result, the original 3D voltage potential analysis problem can be reduced into a 2D voltage analysis problem.

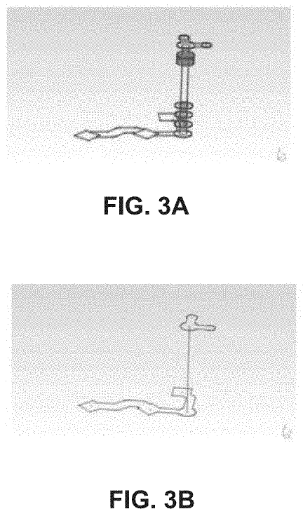

However, for a practical power networks in PCBs, there are still 3D structures as there may be many layers that are connected by vias as shown in FIG. 3a. To mitigate this problem, we regard vertical via as a vertical line segment and represent it with resistive 2-node line element in the FEM method. As shown in FIG. 3b, the original 3D structure has been converted to several 2D planes connected by vertical line segments, which can be represented by 2D elements (lines or triangles) completely, by establishing an approximate 2D model.

To solve the extracted 2D model for a power network, the system first uses 2D elements (lines or triangles) to mesh a 2D plane as described above in Section II. Then the system treats vertical vias and discrete components as pure resistance based on the Ohm's law. Next, the system sets up in given voltage (Dirichlet) or current boundary (Neumann) conditions.

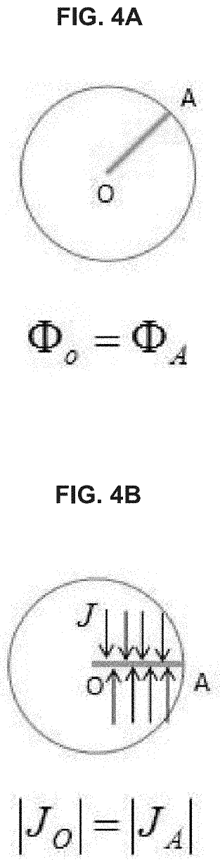

With reference to FIGS. 4a-4b, a round pin pad is taken for demonstration both for voltage and current BCs. Point O is the pin center and A is an arbitrary point within the pin pad. FIG. 4a supposes that line segment OA has identical electrical potential so voltage boundary conditions can be built on the OA element. FIG. 4b supposes that line segment OA has identical current density magnitude so that current boundary conditions can be built on the OA element. Note that the direction of positive current density is ejected from the pin pad into OA line orthogonally.

For voltage boundary condition, which is usually specified by source component pins, the system adds a line element connecting the pin center and an arbitrary point on the edge of the pin, which makes the Dirichlet boundary conditions. The electrical potentials on the line are assumed to be identical, as shown in FIG. 4a.

Similarly, for current boundary condition, which is usually specified by sink component pins, the same measure is taken. It is assumed that the magnitude of current density on the boundary line is the same as shown in FIG. 4b. The current boundary condition is recognized as Neumann BC in the current example. The direction of positive current is ejected from the pin pad into the OA line orthogonal to the X-Y plane.

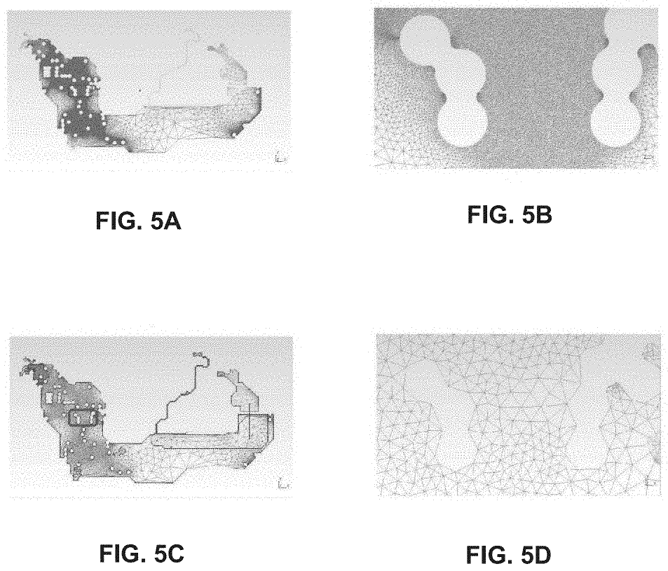

The second approximation method that one embodiment employs controls the number of elements at the cost of a very small accuracy degradation. With reference to FIGS. 5a-5d, an illustration of how the Boundary contour gets simplified after the critical-angle algorithm is applied. FIG. 5a illustrates a dense meshing before it is simplified, having 147383 mesh nodes and 288436 mesh elements. FIG. 5b illustrates a partially enlarged area indicated in the rectangle of FIG. 5(a). FIG. 5c illustrates a sparse meshing after it has been simplified by the system, with 7157 mesh nodes and 13477 mesh elements. FIG. 5d illustrates the partial enlarged area of the rectangle in FIG. 5c after the meshing has been simplified.

In a finite element meshing process, the complex contour may lead to a very large number of elements if very fine lines are used to model the complicated shapes or contours. Such is the case if the cycles and arcs that are very dense meshes are used such as the complicated contours and shapes as shown in FIGS. 5(a) and 5(b). The system described herein operates in recognition that those dense meshes are actually unnecessary as the voltages around those shapes will not change dramatically, at least in the case of the PCB.

Thus, the system uses the Critical Angle concept to reduce the number of contour points and thus control the number of the elements around those contours. Specifically, letting p1, p2, . . . , pn be the point sequence of the contour. Each time the system deletes a point pi if the included angle of the line segments pi−1pi and pipi+1 is greater than the critical angle, and then updates the point range until there is no point to be deleted or there are only three points left. The algorithm below describes the details and FIGS. 5a-5d show that the algorithm significantly reduces the number of elements for the same networks. The number of meshes can be regulated by setting the value of Critical Angle. The smaller the value of Critical Angle is set, the sparser the meshes will be. However, too small of a value will cause the accuracy to be less. After some trial and error, the system has been adjusted so that that the low bound for the Critical Angle is preferably around 150 degrees.

The Critical Angle based contour modeling in meshing process includes the following pseudo code:

Input: An array A of original contour points, Critical Angle

δ, length of array n

Output: A

for i = 1;i ≤ n;i + + do

```
Calculate the included angle θ of line pᵢ₋₁pᵢ and pᵢpᵢ₊₁
  (p₀ = pₙ, pₙ₊₁ = p₁)
  if θ > δ & & n > 3 then
```

```
  Delete pᵢ from A
  n = n − 1
  i = i − 1
```

else if n > 3 then

Continue;

else

Break;

end if
end for
Return A

### IV. EXPERIMENTAL RESULTS AND DISCUSSIONS

The described 2D FEM DC solver has been implemented in C++ with the Armadillo numerical package available the C++ linear algebra library by Conrad Sanderson. The experimental data was collected on Linux severs with an Intel Xeon E5-2698 CPU at 2.3 GHz. The Gmesh program available from Gmish.info was used to generate the 2D mesh for our 2D FEM solver.

The numeration solution of 2D FEM was compared with Cadence Sigrity PowerDC on a industry PCB design, the Galileo PCB. The example tested was a power network, named V1P0 S0. It consisted of one source component pin C3B9.1 with voltage 1V, multiple pins of sink component U2 A5 with total 10 A current and V1P0 S0 net. The copper conductivity was set with 5.959e+7S/m, as PowerDC does by default, and employed the equal current model in pins belonging to U2 A5.

Table I below shows the comparison results of voltage IR drops between PowerDC and the 2D FEM solver.

TABLE I
VOLTAGE IR DROP COMPARISONS AGAINST POWERDC

Voltage at pins (mV)

| U2A5 pin number | PowerDC | 2D FEM |
|---|---|---|
| AD14 | 966.262 | 967.481 |
| AB14 | 966.465 | 967.652 |
| Y14 | 966.612 | 967.727 |
| V14 | 966.558 | 967.707 |
| Y16 | 966.742 | 967.894 |
| V16 | 966.841 | 967.986 |
| AB18 | 966.676 | 967.902 |
| Y18 | 966.796 | 967.968 |
| V18 | 967.229 | 968.26 |
| T18 | 967.378 | 968.386 |
| AB20 | 966.62 | 967.866 |
| Y20 | 967.193 | 968.237 |
| V20 | 967.45 | 968.575 |
| Avg IR drop | 33.168 | 32.028 |

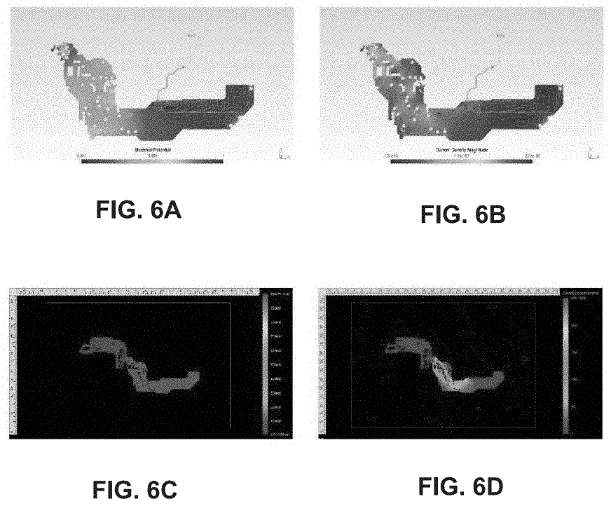

The voltage values calculated by the 2D FEM solver are consistently a little bigger than by those by the PowerDC and the average IR drop was very close. However, the solver takes 5.441 s of CPU time total while PowerDC takes 7.034423 according to its analysis report, reducing time cost by 29.29% against PowerDC. Voltage distribution and current density distribution plots are shown in FIGS. 6a-6d.

FIGS. 6a-d illustrated voltage distribution and current density distributions. FIG. 6a is a voltage distribution plot that resulted from the 2D FEM solver. FIG. 6b is a current density distribution plot that resulted from the 2D FEM solver. FIG. 6c is a voltage distribution plot on the PWR layer that resulted from the PowerDC. FIG. 6d is a current density distribution plot on the PWR layer that resulted from the PowerDC.

The impact of the Critical Angle concept, which allow the system to perform the trade-off between the solver efficiency and accuracy, was reviewed. By setting the value of the Critical Angle, the system can regulate the number of mesh nodes and elements and also the accuracy of the results. In one embodiment, V1P0 S0 was also selected as the test power network. Table II shows the meshing results from Gmsh while different values of the Critical Angle are set.

TABLE II
PERFORMANCE COMPARISON FOR DIFFERENT
CONTOUR MODELINGS IN MESHING

| | Critical Angle (°) | | | |
|---|---|---|---|---|
| Index | 150 | 160 | 170 | 180 |
| Meshing | 0.869719 | 1.04875 | 3.87363 | 16.9746 |
| time (s) | | | | |
| No. of | 6437 | 10049 | 34023 | 146202 |
| nodes | | | | |
| No. of | 13883 | 21461 | 70603 | 298786 |
| elements | | | | |
| Solver | 5.441 | 21.281 | — | — |
| run time (s) | | | | |
| Avg IR | 32.028 | 32.621 | — | — |
| drop (mV) | | | | |

It is clearly seen that the meshing time decreases significantly when the critical angle decreases to 150°. When it reaches below 150°, it causes serious deformation of the contour area and thus poor accuracies. As a result, 150° was determined to be a good trade-off choice between solver efficiency and accuracy.

Described herein is a fast 2D finite element method for DC integrity analysis of PCBs. The new method and system use a 2D mesh instead 3D mesh for the analysis so that the number of elements can be significantly reduced with marginal accuracy loss. A resistive line is also used to replace all the vias. To further reduce the number of elements, the Critical Angle method used to approximate the contours of the complicated shapes in the PCBs so that better accuracy and efficiency trade-off can be made. The proposed 2D FEM DC solver was compared against the commercial Cadence PowerDC solver on an industry PCB design. The new solver shows similar accuracy while delivering 29.29% speedup over PowerDC.

It is to be understood that not necessarily all objects or advantages may be achieved in accordance with any particular implementation of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

What is claimed is:

1. A method of integrity analysis of a printed circuit board, comprising:
using a two-dimensional mesh for the analysis of the printed circuit board to reduce a number of elements in a mesh representing the printed circuit board;
using a resistive line to replace all vias; and
approximating the contours of shapes in the printed circuit board to further reduce the number of elements.

2. The method of claim 1, wherein the step of approximating the contours comprises using a critical angle method.

3. The method of claim 2, wherein the critical angle set in the critical angle method is approximately 150°.

4. The method of claim 1, further comprising reducing a three-dimensional analysis of the printed circuit board to the two-dimensional analysis by assigning a same electrical potential value for each of a plurality of layers of the printed circuit board.

5. A system for integrity analysis of a printed circuit board, comprising:
a processor;
a first set of instructions executable on the processor configured to use a two-dimensional mesh for the analysis of the printed circuit board to reduce the number of elements in a mesh representing the printed circuit board;
a second set of instructions executable on the processor configured to use a resistive line to replace all vias; and
a third set of instructions executable on the processor configured to approximate the contours of shapes in the printed circuit board to further reduce the number of elements.

6. The system of claim 5, wherein the instructions for approximating the contours comprises instructions for using a critical angle method.

7. The system of claim 6, wherein the critical angle set is approximately 150°.

8. The system of claim 5, further comprising a set of instructions executable on the processor for reducing a three-dimensional analysis of the printed circuit board to the two-dimensional analysis by assigning a same electrical potential value for each of a plurality of layers of the printed circuit board.
